(19) United States
(12) Patent Application Publication
(10) Pub. No.: US 2013/0227039 A1
(43) Pub. Date: Aug. 29, 2013

(54) METHOD FOR CARRYING OUT A COMMUNICATION

(71) Applicants: Andreas-Juergen Rohatschek, Wernau/Neckar (DE); Bernd Lutz, Ludwigsburg (DE); Thorsten Huck, Freiberg (DE); Stoyan Todorov, Mannheim (DE)

(72) Inventors: Andreas-Juergen Rohatschek, Wernau/Neckar (DE); Bernd Lutz, Ludwigsburg (DE); Thorsten Huck, Freiberg (DE); Stoyan Todorov, Mannheim (DE)

(73) Assignee: Robert Bosch GmbH, Stuttgart (DE)

(21) Appl. No.: 13/818,912

(22) PCT Filed: Jul. 27, 2011
(86) PCT No.: PCT/EP2011/062911

§ 371 Date: May 10, 2013

(30) Foreign Application Priority Data
Aug. 26, 2010 (DE) 10 2010 039 782.2

(51) Int. Cl. H04L 12/58

(52) U.S. Cl. CPC H04L 51/00
USPC 709/206

(57) ABSTRACT

In a method for carrying out a communication in a control unit, a message having an identification number is transmitted between a microcontroller and at least one system component, this identification number being used in the at least one system component as basis for a decision with the aid of a message filter as to whether this message is forwarded to a first module for linking a physical layer or to a second module for functions of the system component.

### BACKGROUND OF THE INVENTION

1. Field of the Invention

The present invention relates to a method for carrying out a communication in a control unit, and to such a control unit and a message filter for carrying out the method.

2. Description of the Related Art

At present, control units usually consist of a microcontroller and one or more system components which realize additional functionalities. In known control units the microcontroller generally uses dedicated interfaces such as an SPI (Serial Peripheral Interface) or peripheral buses to communicate directly with these system components. The exchange of status values, sensor values, actuation data of actuators, and the configuration of the system component take place via this interface. This communication is also referred to as chip-to-chip communication.

At the same time, this interplay between microcontroller and system components is utilized for the communication of the control unit with the outside world, via a multiplicity of interfaces such as CAN (controller area network), FlexRay, Bluetooth or Ethernet. Toward this end the microcontroller implements the actual protocol stack in hardware or in software, while the system component assumes the physical data representation. A data link, which is specified by the standard of the utilized interface, e.g., a Media Independent Interface MII at 100 MBit-Ethernet, is provided between these components. It should be noted that all considered communication interfaces use an unambiguous identification of the communication participants (see MAC address for Ethernet and Bluetooth), and are packet-oriented as a rule.

When the communication in a control unit is involved, an embedding of the chip-to-chip communication in communication interfaces, e.g., CAN, FlexRay, Bluetooth or Ethernet, is endeavored.

### BRIEF SUMMARY OF THE INVENTION

According to the present invention, the introduction of an unambiguous identification number from the number range of the utilized protocol, and the introduction of a supplementary module which separates messages to the system component from the remaining messages on the system component or adds them to the remaining messages again are provided, as well as the associated programming paradigm. In this context it must be taken into account that the messages for the system component do not necessarily run through the physical layer of the utilized communication protocol. System components may be pure analog switching circuits, digital switching circuits, software solutions and mixtures thereof. The messages may be exchanged block by block or in connection-oriented form.

One essential advantage of the described method is the reduced number of required connections between microcontroller and system component, and thus a reduced number of pins. Furthermore, when using communication interfaces featuring a high data throughput, a higher bandwidth between microcontroller and system component is available than would be provided by the interfaces such as SPIs that are traditionally used in control units. The addressing of the system component moreover takes place via a standardized software interface. Fewer connections result in cost savings and save an additional EMC-source.

Additional advantages and refinements of the present invention result from the description and the attached figures.

It is understood that the aforementioned features and the features still to be outlined in the following text are able to be used not only in the combination indicated but in other combinations as well or by themselves, without departing from the scope of the present invention.

### BRIEF DESCRIPTION OF THE DRAWINGS

FIG. 1 shows a schematic representation of a specific embodiment of the described control unit.

FIG. 2 shows a schematic representation of a message filter when a message is transmitted from a microcontroller.

FIG. 3 shows a schematic representation of the message filter when a message is transmitted to the microcontroller.

### DETAILED DESCRIPTION OF THE INVENTION

The present invention is schematically illustrated in the figures on the basis of specific embodiments and hereinafter will be described in greater detail with reference to the drawing.

The figures are described successively and comprehensively, and identical reference numerals denote identical components.

FIG. 1 shows one specific embodiment of the described control unit in a schematic, greatly simplified representation, the control unit being denoted by reference numeral 10 overall. This control unit 10 includes a microcontroller 12 and a system component 14. Only one system component 14 is shown in this illustration. As a rule, control unit 10 includes a number of system components 14, which are provided for realizing different functions or functionalities.

A core 16 and a module 18 which implements the protocol layer of a communication interface 20 are provided in microcontroller 12. Module 18 is a CAN module or an Ethernet MAC module, for instance. Communication interface 20 typically is a protocol-specific interface (such as an MII). System component 14 includes a message filter 22, a first module 24 for linking the physical layer, and a second module 26 for other functions of system component 14. An identification number 28 of system component 14 is assigned in addition.

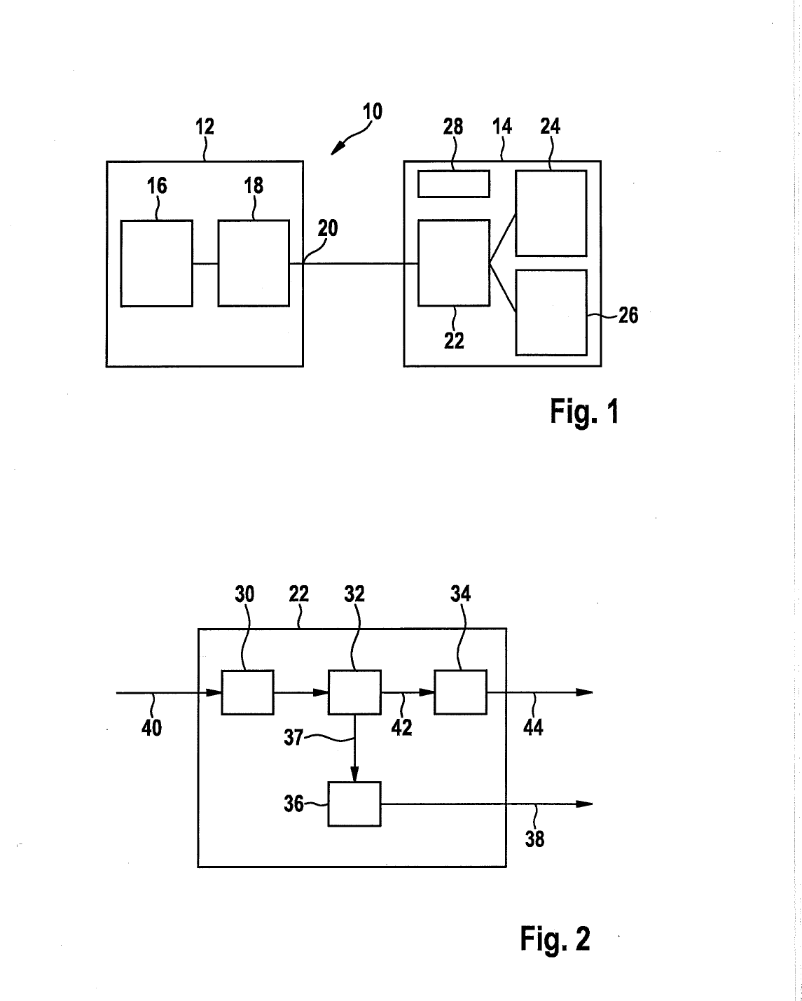

The principal structure of control unit 10 therefore is shown in the illustration. Accordingly, in addition to the actual computer core, i.e., core 16, microcontroller 12 includes module 18, which implements the protocol layer of communication interface 20. In contrast to what is known from the related art, this module 18 is not connected directly to first module 24 for linking the physical layer via protocol-specific communication interface 20, but instead, message filter 22 is connected in-between. Identification number 28 of system component 14 is available in this message filter 22, so that the message filter is able to classify messages on protocol-specific communication interface 20 between microcontroller 12 and system component 14 based on this identification number 28. FIG. 2 shows the submodules required for this purpose. Identification number 28 may be fixedly assigned to a particular system component 14 and permanently set during the production. As an alternative, the identification number can be newly set during the running period via special messages (e.g., MAC address 0 as identification of the special message).

FIG. 2 illustrates the function of message filter 22 when a message is transmitted from microcontroller 12. The figure shows a first unit 30 for detecting an identification number, a second unit 32 for comparing the identification number, a third unit 34 for forwarding a message, and a fourth unit 36 for the protocol stack.

If a message is transmitted from microcontroller 12 to system component 14 (arrow 40), then this message first passes through the protocol stack (module 18) of microcontroller 12 and is sent via communication interface 20 to system component 14. Identification number 28 of system component 14 is encoded in the message. First unit 30 detects identification number 28 within message filter 22. Second unit 32 checks identification number 28 of the message against identification number 28 of system component 14, comparable to a router, but possibly using a reduced function scope. It detects the message for system component 14 and instead of forwarding it to first module 24 for the physical layer, it forwards it to a system-component-internal protocol stack (arrow 37). This protocol stack removes the useful data for the system component and forwards this data to the other modules of system component 14 (arrow 38). The protocol stack on system component 14 may be very small if the communication adheres to a fixed data format between system component 14 and microcontroller 12.

If a message is transmitted from microcontroller 12 to the actual communication interface, then it does not include identification number 28 of system component 14. Second unit 32 for the comparison thereupon forwards the message to physical-layer module 24 (arrow 42), which further processes the message according to standard and forwards it to the physical layer (arrow 44).

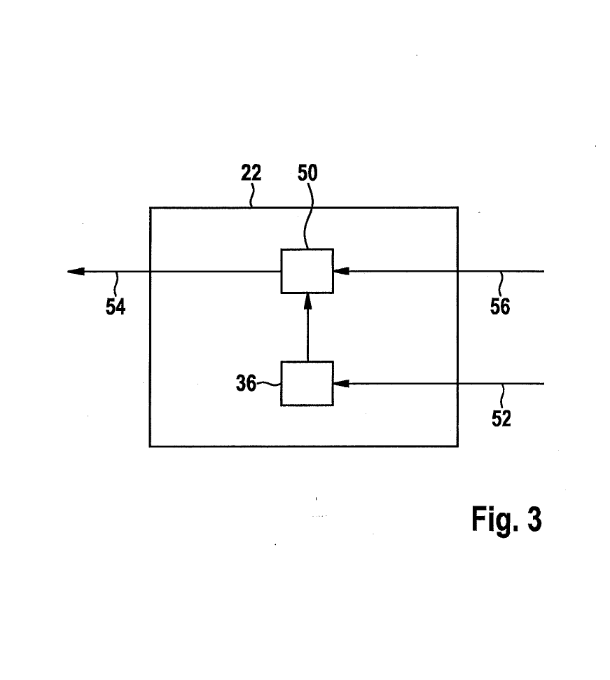

FIG. 3 shows message filter 22 together with the components required when messages are sent to microcontroller 12. The illustration shows an arbiter 50, that is to say, a component which regulates or prioritizes accesses or access collisions. Additionally shown is fourth unit 36 for the protocol stack.

When messages are to be transmitted to microcontroller 12, message filter 22 may have a simpler design. FIG. 3 shows the function. Messages (arrow 52) of system component 14 are first adapted again to the format of communication interface 20 between microcontroller 12 and system component 14 by the small protocol stack (unit 36). These messages and the messages that are received via communication interface 20 and physical-layer module 24 arrive at arbiter 50, which coordinates the forwarding of the messages to microcontroller 12 (arrow 54). Arrow 56 illustrates potential messages from the physical layer.

Standardized interfaces such as Ethernet have a standardized programming interface in the software as well. The required software between hardware module and software interface, i.e., the driver, usually is included by the module manufacturer. Then this standardized programming interface is also usable for the communication with the system component. It is used to program the system component, for instance when Ethernet or Bluetooth are utilized in Unix-type operating systems, e.g., via sockets, that is to say, software modules for the exchange of data. In both cases the unambiguous identification number is a MAC address; in the case of Ethernet, it is also possible to use an IP address. Due to the standardized software interfaces, the software thus is extremely interface-independent.

The afore-described structure assumes that messages to system component 14 are sent only from microcontroller 12. In the same way, system component 14 transmits messages only to microcontroller 12. As an alternative, message filter 22 is also adaptable in such a way that system component 14 additionally receives and/or transmits messages via communication interface 20. The structure then corresponds to the structure in FIG. 2, but with a reversed data direction between communication interface 20 and system component 14 and between microcontroller 12 and system component 14. As a result, for example, it is possible for a central control unit to communicate directly with system component 14, without including microcontroller 12. Because of this option, various implementations are able to be realized:
A safety switch-off of actuators by other control units;
failsafe running functions in case of a detected microcontroller defect;
direct readout of sensor values that are used by multiple control units (e.g., wheel sensors for ESP, engine control and navigation system), without additional computation time for the provision on the microcontroller;
a client-server model of control units: a central control unit assumes a large part of the functions; the other microcontrollers perform only a few functions. However, both must be able to have access to the system component. The local controllers, in particular, may be used for functional safety only, for instance, and operate as checker core. In so doing, they plausibilize sensor/actuator values by suitable functions, or they check the function of the central control unit and the system component by means of a question/answer game.

Depending on the protocol, an additional filter in the direction of the microcontroller, which does not transmit messages for the system component to the microcontroller, may be required as well in such a case. Altogether, the following bidirectional communication options are then available via this implementation:
communication of different microcontrollers from different control units;
communication of the microcontroller with the system component within a control unit;
communication of a microcontroller with the system component of other control units;
communication between system components in different control units (completely without participation of microcontrollers).

Within a system, multiple interfaces may have the communication capability between system component and microcontroller described in the present invention. As a result, for example, a redundant design is possible or the communication channel of the chip-to-chip communication may be dynamically adaptable to the capacity utilization of the various interfaces. In addition, the bandwidth of the selected interface is insufficient, as the case may be. An additional interface is able to further increase the bandwidth.

Both a homogeneous implementation, e.g., 2× CAN, and a heterogeneous implementation, e.g., 1× CAN, 1× FlexRay, is able to be selected.

The introduced method in particular is realized using a control unit of the type described. When implementing the method, at least one system component as described by the above comments is used regularly in the control unit specified for the implementation. As a rule, the system component is provided with a message filter of the type described.

This makes it possible to save a connection in the communication between microcontroller and system component within a control unit.

1-10. (canceled)

11. A method for carrying out a communication in a control unit between a microcontroller and at least one system component, comprising:
providing an identification number to a message to be transmitted from the microcontroller to the at least one system component;
determining, with the aid of a message filter using the identification number, whether the message is forwarded to one of (i) a first module of the at least one system component for linking a physical layer, or (ii) a second module for functions of the system component.

12. The method as recited in claim 11, further comprising:
sending a message from the at least one system component to the microcontroller.

13. The method as recited in claim 12, wherein a central control unit, which is distinct from the microcontroller, communicates directly with the system component.

14. A control unit for carrying out a communication, comprising:
a microcontroller having a core and a module implementing a protocol layer of a communication interface;
at least one system component having a first module for linking a physical layer and a second module for functions of the system component; and
a message filter assigned to the system component, wherein the message filter is configured to forward a selected message to one of the first module or the second module on the basis of an identification number assigned to the selected message.

15. The control unit as recited in claim 14, further comprising:
an additional interface provided between the microcontroller and the at least one system component.

16. A system component for a control unit, comprising:
a first module for linking a physical layer;
a second module for functions of the system component; and
a message filter configured to forward a received message, on the basis of an identification number assigned to the message, to one of the first module or to the second module.

17. The system component as recited in claim 16, wherein the message filter includes a first unit for detecting the identification number and a second unit for checking the identification number.

18. The system component as recited in claim 17, wherein the message filter has a third unit for forwarding the message to a physical layer.

19. The system component as recited in claim 18, wherein the message filter has a fourth unit for a protocol stack.

20. The system component as recited in claim 19, wherein the message filter has an arbiter for access regulation.
